(19) United States
(12) Patent Application Publication
(10) Pub. No.: US 2017/0020363 A1
(43) Pub. Date: Jan. 26, 2017

(54) Lint Roller Device

(71) Applicant: Lolita Bonick, Plainfield, IL (US)

(72) Inventor: Lolita Bonick, Plainfield, IL (US)

(21) Appl. No.: 15/219,203

(22) Filed: Jul. 25, 2016

Related U.S. Application Data
(60) Provisional application No. 62/196,594, filed on Jul. 24, 2015.

(51) Int. Cl. A47L 25/00; B25G 1/04

(52) U.S. Cl. CPC A47L 25/005; B25G 1/04

(57) ABSTRACT

A lint roller device for cleaning loose debris from a surface is provided. The lint roller device comprises an elongated support pole having a first end and a second end and a rolling spool having a first end and a second end. The rolling spool is rotatably mounted to the second end of the support pole. A plurality of adhesive sheets are sequentially wrapped about the rolling spool with each sheet individually removable from the rolling spool thereby exposing another adhesive sheet. The adhesive sheets enable a user to effortlessly pick up loose debris from the surface while comfortably standing upright.

### CLAIM OF PRIORITY

This patent application claims priority under 35 USC 119 (e) (1) from U.S. Provisional Patent Application Ser. No. 62/196,594 filed Jul. 24, 2015, of common inventorship herewith entitled, “Quick Stick Pick Up,” which is incorporated herein by reference as though the same were set forth in its entirety.

### FIELD OF THE INVENTION

The present invention pertains to the field of cleaning supplies, and more specifically to the field of adhesive lint rollers.

### BACKGROUND OF THE INVENTION

There is little dispute that household chores are a fact of life for most people. Whether scrubbing countertops and sinks, polishing furniture, vacuuming carpet and cleaning windows, chores are necessary tasks which are done regularly to ensure a healthy and clean household environment. In particular, maintaining clean flooring is of utmost concern for many people. Easily soiled by the continuous footsteps of family members and pets, high traffic areas of hard flooring, particularly those in front entrance ways and bathrooms and kitchens, are often littered with dirt, dust, bits of paper and debris. Unattractive, dirty flooring detracts from overall decor of a room and leads to an unclean living environment. Most consumers regularly sweep or mop their floor to eradicate this debris and maintain a sanitary household. Often, only small spots on a flooring need to be cleaned and utilizing a heavy vacuum cleaner or retrieving a broom is unnecessary to complete a quick clean up. Whether a few tufts of pet hair sullying a throw rug or errant bits of confetti spilled when opening a holiday gift, some cleaning tasks are small but need to be performed in a timely manner to avoid spreading debris through one's home.

The prior art has put forth several designs for adhesive lint rollers. Among these are:

U.S. Pat. No. 8,490,236 to Tylor Christian Ross describes a combination sticky roller and brush for dislodging and collecting debris from a plurality of different types of surfaces. The present invention utilizes a rubber brush to dislodge debris such as hairs, dusts or dirt from a surface. The device includes a compartment with a cover lid that conceals a sticky roller. Once the debris is uprooted from a surface, the user is able to roll the sticky roller over the surface to pick up and retain the debris. The present invention is used on fabrics or other textiles surfaces and is convenient for use anywhere due to its travel size and unique configuration.

U.S. Pat. No. 5,533,223 to Huang C. Ho describes a cleaning sweeper that comprises an adhesive paper roll, a reel support frame, a dual directional paper cutter and a handle. The adhesive paper roll is wound on a reel fastened pivotally with the reel support frame. As the adhesive paper roll is moved on the surface of a carpet or floor, the dirt on the surface of the carpet or floor is attached to the adhesive paper roll, which becomes soiled gradually. The soiled paper is cut off with a paper cutter mounted pivotally in the reel support frame. The paper cutter is capable of preventing the adhesive surface of the adhesive paper roll from making contact with the surface of a floor or wall when the cleaning sweeper is not in use temporarily and is laid on the floor or hung on the wall.

U.S. Pat. No. 3,742,547 to M. Sohmer describes a tacky roller flooring cleaning tool employing disposable tacky material. An elongated handle at right angles to the axis of the roller provides a convenient tool. A protective hanger is provided.

None of these prior art references describe the present invention.

### SUMMARY OF THE INVENTION

It is an object of the present invention to provide a portable, adhesive lint roller that is mounted to an elongated support pole configured to enable a user to effortlessly pick up debris off carpeting and flooring while comfortably standing upright.

The present invention is a lint roller device for cleaning loose debris from a surface. The lint roller device comprises an elongated support pole having a first end and a second end and a rolling spool having a first end and a second end. The rolling spool is rotatably mounted to the second end of the support pole. A plurality of adhesive sheets are sequentially wrapped about the rolling spool with each sheet individually removable from the rolling spool thereby exposing another adhesive sheet. The adhesive sheets enable a user to effortlessly pick up loose debris from the surface while comfortably standing upright.

In addition, the present invention includes a method for cleaning loose debris from a surface. The method comprises providing an elongated support pole having a first end and a second end, providing a rolling spool having a first end and a second end, rotatably mounting the rolling spool mounted to the second end of the support pole, sequentially wrapping a plurality of adhesive sheets about the rolling spool, removing each sheet individually from the rolling spool thereby exposing another adhesive sheet, and enabling a user to effortlessly pick up loose debris from the surface while comfortably standing upright.

The present invention further includes a lint roller device for cleaning loose debris from a surface. The lint roller device comprises an elongated, telescoping support pole having a first end and a second end and a horizontal support arm is mounted on the second end of the support pole. A rolling spool is provided having a first end and a second end with the rolling spool is rotatably mounted to the second end of the support pole. A plurality of adhesive sheets are sequentially wrapped about the rolling spool with each sheet individually removable from the rolling spool thereby exposing another adhesive sheet. The horizontal support arm is insertable into the first end of the rolling spool. The adhesive sheets enable a user to effortlessly pick up loose debris from the surface while comfortably standing upright.

### BRIEF DESCRIPTION OF THE DRAWINGS

FIG. 1 is a perspective view illustrating a lint roller device, constructed in accordance with the present invention, showing the lint roller device in an extended position with a ring, curved handle, and rotatable collar for extending and rotating the handle.

FIG. 2 is a perspective view illustrating the lint roller device, constructed in accordance with the present invention, with the lint roller device in a retracted position.

FIG. 3 is a close up perspective view of the lint roller device, constructed in accordance with the present invention, showing alternating colored, tear off sheets with nonstick edges.

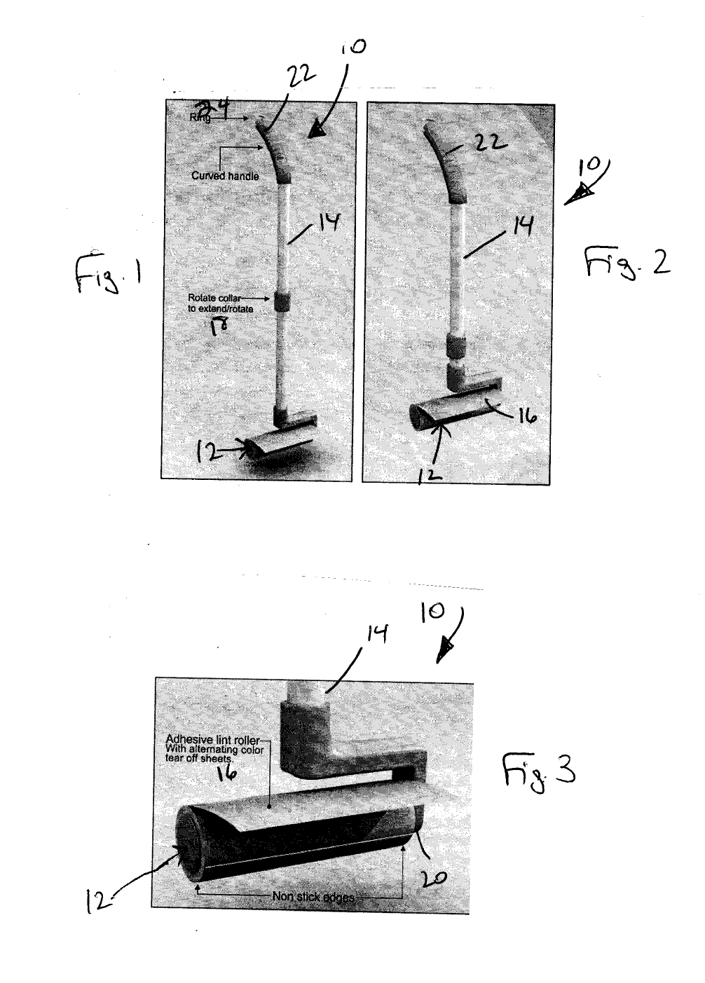

### DETAILED DESCRIPTION OF THE INVENTION

The present invention, hereinafter referred to as the Lint Roller Device, indicated generally at 10, is a lint rolling spool 12 mounted to an elongated support pole 14 configured to enable a user to effortlessly pick up debris off carpeting and flooring while comfortably standing upright. The Lint Roller Device 10 is a compact and easily accessible tool for everyday use in cleaning loose debris, dust, hair and other residue from carpets, area rugs, hard surface flooring, upholstery, bedding and curtains. Containing disposable peel away sheets 16, the Lint Roller Device 10 of the present invention requires no cleaning of brushes or sponges, no emptying collection containers, and no replacing batteries or tripping over power cords.

The Lint Roller Device 10 of the present invention is comprised of two main components, the actual lint rolling spool 12 and a durable adjustable support handle or pole 14 on which the lint rolling spool 12 is mounted. The lint rolling spool 12 has a first end and a second end with the plurality of sticky adhesive sheets 16 wrapped about the rolling spool 12. In a preferred embodiment, approximately seventy adhesive sheets 16 are wrapped about the rolling spool 12, facilitating dozens of uses of the present invention. The roll of sticky adhesive sheets 16 are configured to pick up hair, lint, dust, dirt, and other debris that are sullying a floor.

In a preferred embodiment, the lint rolling spool 12 of the Lint Roller Device 10 of the present invention is preferably cylindrical in shape and measures approximately ten inches in length and three to four inches in depth. A removable covering, which is applied over the lint rolling spool 12 and adhesive sheets 16 when in storage, can protect the adhesive surface of the adhesive sheets 16. The lint roller spool 12 is preferably disposable and replaceable.

In an embodiment of the Lint Roller Device 10 of the present invention, each of the adhesive sheets 16 have a non-stick edge adjacent the first end and the second end of the rolling spool 12. By keeping the edges of the adhesive sheets 16 non-stick, loose debris will be inhibited from sticking to the edges of the adhesive sheets 16.

The support pole 14 of the Lint Roller Device 10 of the present invention has a first end and a second end. The support pole 14 is a telescopic adjustable length support pole 14 to accommodate users of various heights as well as children. In this manner, the support pole 14 has at least two sections with a rotatable collar 18 or the like between each of the sections. When the collar 18 is rotatably loosened, each section of the support pole 14 is movable relative to an adjacent section allowing the length of the support pole 14 to be adjusted. When the collar 18 is rotatably tightened, each section of the support pole 14 is releasably secured to an adjacent section of the support pole 14 thereby releasably maintaining the desired length of the support pole 14.

Located at the second end of the support pole 14 of the Lint Roller Device 10 of the present invention is a horizontal support arm 20. The support arm 20 is insertable within the first end of the rolling spool 12, over which the lint rolling spool 12 is applied. A simple interlocking fastener or comparable holder is incorporated into the configuration of the present invention to secure the rolling spool 12 during use. In a preferred embodiment, with the rolling spool 12 positioned on the support arm 20, the support pole 14 is positioned in the approximate center of the rolling spool 12 allowing the user to more easily use and control the operation of the Lint Roller Device 10.

The second end of the support pole 14 of the Lint Roller Device 10 of the present invention preferably culminates in an ergonomic, plastic coated, grooved, nonskid, curved handle grip 22. The handle grip 22 can have a metal ring 24 secured thereto from which the Lint Roller Device 10 can be hanged and stored.

Manufactured of lightweight metal material, the support pole 14 of the Lint Roller Device 10 of the present invention preferably measures approximately thirty six to thirty eight inches in total length, when fully extended. Lint rollers incorporating the rolling spool 12 with adhesive sheets 16 thereon are available separately to replace a lint roller 12 being used, from which all adhesive sheets 16 have been used and disposed.

Using the Lint Roller Device 10 of the present invention simply involves loading a companion rolling spool 12 on the horizontal support arm 20 of the support pole 14 and removing the protective cover from around the adhesive sheets 16, revealing the sticky adhesive sheeting 16. The user then glides the Lint Roller Device 10 of the present invention back and forth across the floor, allowing the sticky paper 16 to naturally pick up hair, lint, dust, dirt, and other debris on contact. Once a sheet of sticky paper 16 is completely covered with debris, the user simply peels the sticky paper 16 off the roller, revealing a fresh sheet positioned below.

The Lint Roller Device 10 of the present invention provides house cleaners with a simple and expeditious means of cleaning flooring. The Lint Roller Device 10 enables a user to effortlessly collect loose hairs, lint, dust, and other debris from hard flooring, rugs, and carpets while comfortably standing upright, without requiring use of a heavy vacuum or broom. A user executes quick clean ups without requiring a power outlet. A practical alternative to emptying vacuum canisters or overflowing dust pans, the Lint Roller Device 10 is a sensible approach to routine home maintenance challenges. While the Lint Roller Device 10 is configured expressly for general household use, the Lint Roller Device 10 also is highly functional for maintenance workers, housekeepers and similar professionals.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A lint roller device for cleaning loose debris from a surface, the lint roller device comprising:
an elongated support pole having a first end and a second end;
a rolling spool having a first end and a second end, the rolling spool is rotatably mounted to the second end of the support pole; and
a plurality of adhesive sheets sequentially wrapped about the rolling spool, each sheet individually removable from the rolling spool thereby exposing another adhesive sheet;
wherein the adhesive sheets enable a user to effortlessly pick up loose debris from the surface while comfortably standing upright.

2. The lint roller device of claim 1 wherein the support pole is a telescopic adjustable length support pole.

3. The lint roller device of claim 2 wherein the support pole has at least two sections with a rotatable collar between each of the sections, wherein when the collar is rotatably loosened, each section of the support pole is movable relative to an adjacent section allowing the length of the support pole to be adjusted, wherein the collar is rotatably tightened, each section of the support pole is releasably secured to an adjacent section of the support pole thereby releasably maintaining the desired length of the support pole.

4. The lint roller device of claim 1 and further comprising:
a horizontal support arm mounted on the second end of the support pole;
wherein the horizontal support arm is insertable into the first end of the rolling spool.

5. The lint roller device of claim 4 wherein the support pole is positioned in the approximate center of the rolling spool.

6. The lint roller device of claim 1 and further comprising:
an interlocking fastener for releasably securing the rolling spool to the support pole.

7. The lint roller device of claim 1 and further comprising:
a curved handle grip formed on the second end of the support pole.

8. The lint roller device of claim 1 and further comprising:
a ring mounted to the second end of the support pole.

9. The lint roller device of claim 1 wherein each of the adhesive sheets has a non-stick edge adjacent the first end and the second end of the rolling spool.

10. The lint roller device of claim 1 and further comprising:
a removable covering positionable over the rolling spool and the plurality of adhesive sheets.

11. The lint roller device of claim 1 wherein the lint rolling spool is disposable and replaceable.

12. The lint roller device of claim 1 wherein the lint roller device is usable on carpets, area rugs, hard surface flooring, upholstery, bedding, and curtains.

13. The lint roller device of claim 1 wherein the lint roller device cleans dust, hair, and other residue.

14. A method for cleaning loose debris from a surface, the method comprising:
providing an elongated support pole having a first end and a second end;
providing a rolling spool having a first end and a second end;
rotatably mounting the rolling spool mounted to the second end of the support pole;
sequentially wrapping a plurality of adhesive sheets about the rolling spool;
removing each sheet individually from the rolling spool thereby exposing another adhesive sheet; and
enabling a user to effortlessly pick up loose debris from the surface while comfortably standing upright.

15. A lint roller device for cleaning loose debris from a surface, the lint roller device comprising:
an elongated, telescoping support pole having a first end and a second end;
a horizontal support arm mounted on the second end of the support pole;
a rolling spool having a first end and a second end, the rolling spool is rotatably mounted to the second end of the support pole; and
a plurality of adhesive sheets sequentially wrapped about the rolling spool, each sheet individually removable from the rolling spool thereby exposing another adhesive sheet;
wherein the horizontal support arm is insertable into the first end of the rolling spool; and
wherein the adhesive sheets enable a user to effortlessly pick up loose debris from the surface while comfortably standing upright.

16. The lint roller device of claim 15 wherein the support pole has at least two sections with a rotatable collar between each of the sections, wherein when the collar is rotatably loosened, each section of the support pole is movable relative to an adjacent section allowing the length of the support pole to be adjusted, wherein the collar is rotatably tightened, each section of the support pole is releasably secured to an adjacent section of the support pole thereby releasably maintaining the desired length of the support pole.

17. The lint roller device of claim 15 wherein the support pole is positioned in the approximate center of the rolling spool.

18. The lint roller device of claim 15 and further comprising:
a curved handle grip formed on the second end of the support pole.

19. The lint roller device of claim 15 wherein each of the adhesive sheets has a non-stick edge adjacent the first end and the second end of the rolling spool.

20. The lint roller device of claim 15 and further comprising:
a removable covering positionable over the rolling spool and the plurality of adhesive sheets.
